(19) United States
(12) Patent Application Publication
(10) Pub. No.: US 2003/0168181 A1
(43) Pub. Date: Sep. 11, 2003

(54) Film-sealing device capable of adjusting the sealing breadth

(75) Inventor: Chien-Wen Lee, Taichung (TW)

Correspondence Address: BROWDY AND NEIMARK, P.L.L.C., 624 NINTH STREET, NW, SUITE 300, WASHINGTON, DC, 20001-5303, US

(73) Assignee: CHI YHEI TECH INTERNATIONAL, Tai Ping City (TW)

(21) Appl. No.: 10/198,083

(22) Filed: Jul. 19, 2002

(30) Foreign Application Priority Data
Mar. 8, 2002 (TW) 91202759

(51) Int. Cl. B32B 31/00

(52) U.S. Cl. 156/580

(57) ABSTRACT

The present invention is to provide a film-sealing device comprising a main base, two side bases mounted oppositely on the main base with at least one of which being able to move on the main base, two bearing bases and two press bases respectively mounted on the two side bases and being able to adjust their positions on the side bases. Each the side base has a concavity indented from the top surface thereof. One of the side bases has a shoulder located at the inner top edge thereof. Each bearing base is provided at the inner side thereof with a bolster corresponding in location to the concavity of said side base substantially. The top surface of one of the bolsters is substantially flush with the shoulder of said side base. Each press base is provided at the inner side thereof with a heating element which is provided at the bottom thereof with a flange corresponding in location above the bolster. The two press bases are able to move up and down on the side bases.

### FIELD OF THE INVENTION

The present invention relates to a packing equipment for IC packages or electronic elements, and more particularly to a film-sealing service capable of adjusting the sealing breadth.

### BACKGROUND OF THE INVENTION

What demonstrated in FIG. 1 is a portion of a conventional packing strap 90 applied to packing IC packages or electronic elements in large quantities. The packing strap 90 features a strip form which can be twined into a reel-like body. The strap 90 is provided along the longitudinal direction thereof with a plurality of recessed chambers 91 arranged in a predetermined interval for receiving the IC packages or electronic elements respectively. The openings of the recessed chambers of the strap 19 are then sealed by a transparent film after installing the IC packages into the chambers, thereby completing the packing process.

The aforesaid film-sealing process is carried out by a special mechanical equipment (film-sealing device) pulling out the reel-form packing strap which is intertwined beforehand and is already inlaid with IC packages or electronic elements. It is to be noted that one side of the packing strap 90 has circular holes 92 distributed in equal distance along a longitudinal direction for engaging a gear-like roller of the special mechanical equipment such that the twined strap can be pulled out. In addition, a reel-form transparent film is also pulled out by the special mechanical equipment and guided to the top face of the packing strap to be pressed to the packing strap by two heaters in longitudinal direction so as to make two sides of the film adherent to two sides of the top face on the packing strap. By following this process, the transparent film will be sealed segment-by-segment by means of an intermittent driving, and subsequently, and on the other hand have the packing strap which is sealed by film arranged in reel form.

In prior art, the packing strap also features different breadth according to the form and dimension of the IC package or electronic element. Conventional film-sealing device for sealing the packing strap, however, merely applies to one single specification of breadth. In other words, considerable quantity of film-sealing device available to handle packing straps of different breadth not only take up room but cause an expensive cost.

### SUMMARY OF THE INVENTION

The primary objective of the present invention is to provide a film-sealing device for sealing the packing strap that can facilitate a simple and swift adjustment for operators and may be applied to packing straps of different breadth, thus enabling to lower the device cost and reduce room taken up by the device.

To achieve aforesaid objective, a film-sealing device provided by the present invention comprises a main base, two side bases mounted oppositely on the main base with at least one of which being able to move leftward and rightward on the main base, two bearing bases respectively mounted on the two side bases and being able to adjust leftward and rightward their positions on the side bases, and two press bases respectively mounted on the two side bases and being able to adjust leftward and rightward their positions on the side bases. Each the side base has a concavity indented from the top surface thereof. One of the side bases has a shoulder located at the inner top edge thereof. Each bearing base is provided at the inner side thereof with a bolster corresponding in location to the concavity of said side base substantially. The top surface of one of the bolsters is substantially flush with the shoulder of said side base. Each press base is provided at the inner side thereof with a heating element which is provided at the bottom thereof with a front-and-backwardly extended flange corresponding in location above the bolster. The two press bases are able to move up and down on the side bases.

### BRIEF DESCRIPTION OF THE DRAWINGS

FIG. 1 is a perspective view of a portion of a conventional packing strap.

FIG. 2 is a partial perspective view of a preferred embodiment of the present invention, wherein the film-adjusting mechanism is not shown.

FIG. 3 is a sectional view taken along line 3-3 in FIG. 2.

FIG. 4 is a partial exploded view of the preferred embodiment of the present invention, wherein the film-adjusting mechanism is not shown.

FIG. 5 shows another partial exploded view of the preferred embodiment of the present invention, wherein the film-adjusting mechanism and the press bases are not shown.

FIG. 6 is another partial perspective view of the preferred embodiment of the present invention, showing a part of the side bases and the film-adjusting mechanism only.

FIG. 7 is a partial exploded view in corresponding to FIG. 6.

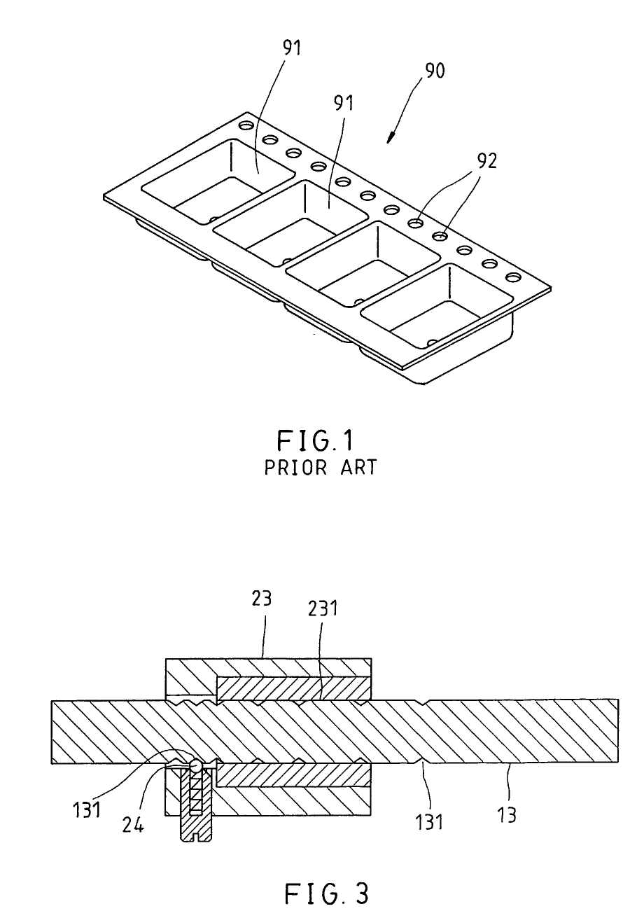

### DETAILED DESCRIPTION OF THE INVENTION

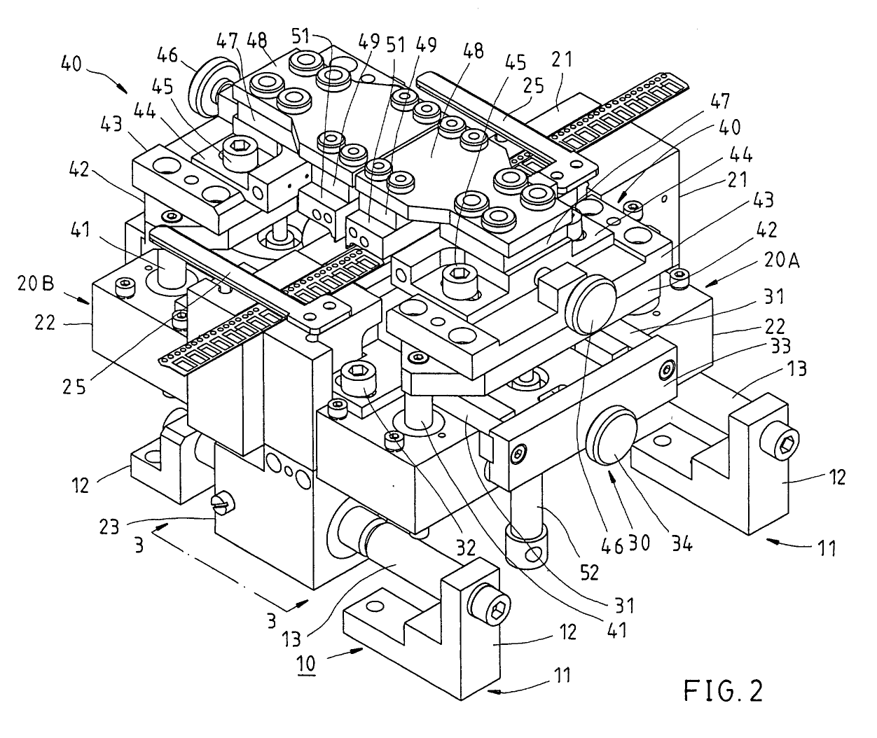

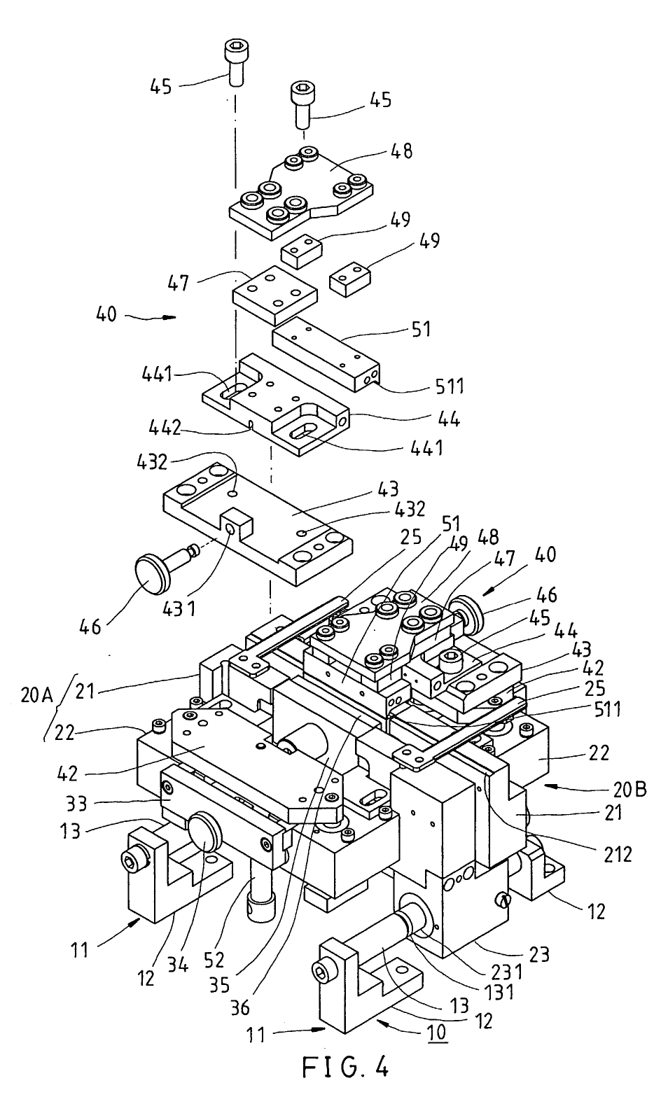

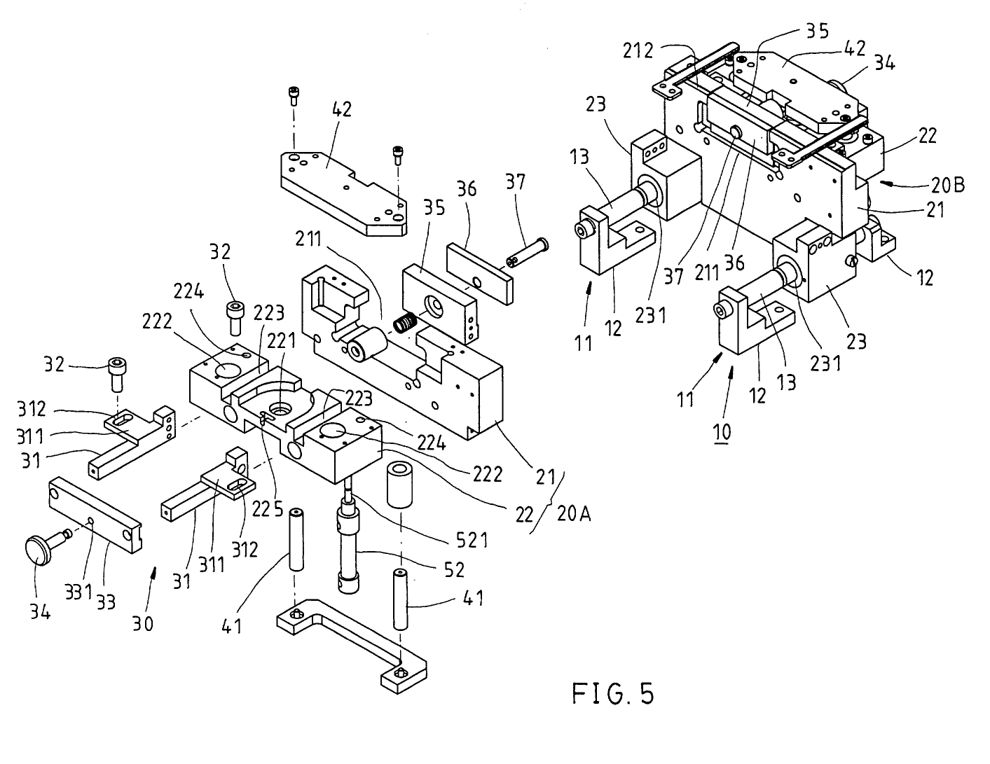

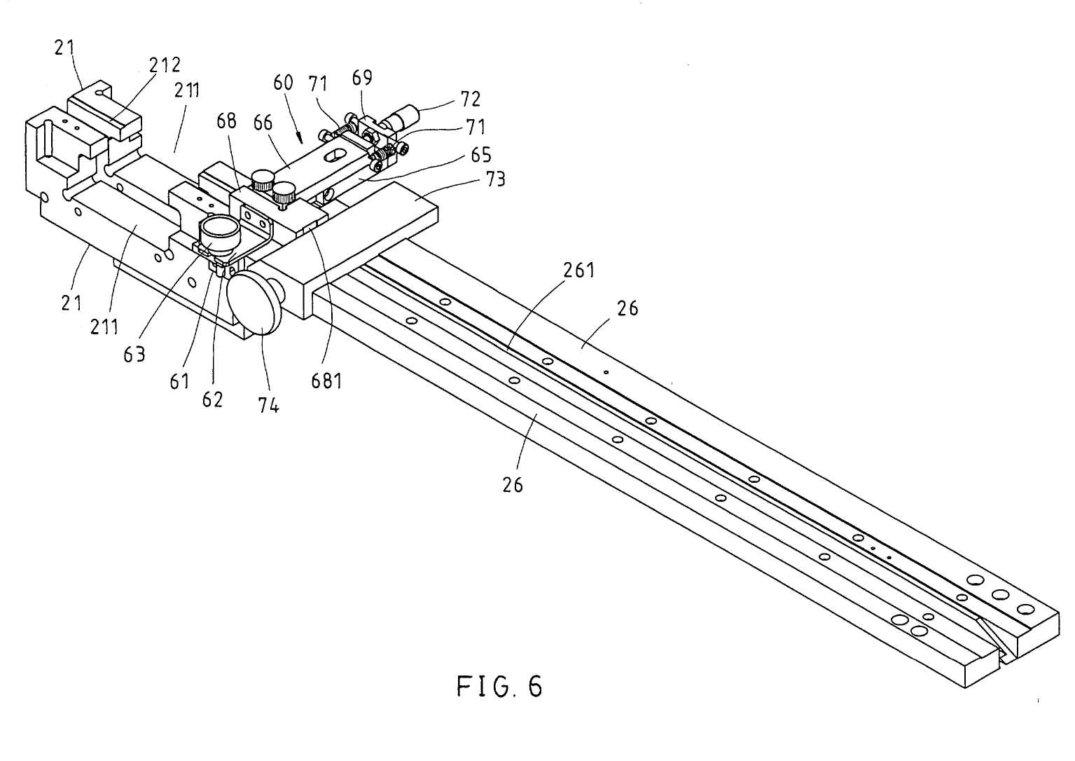

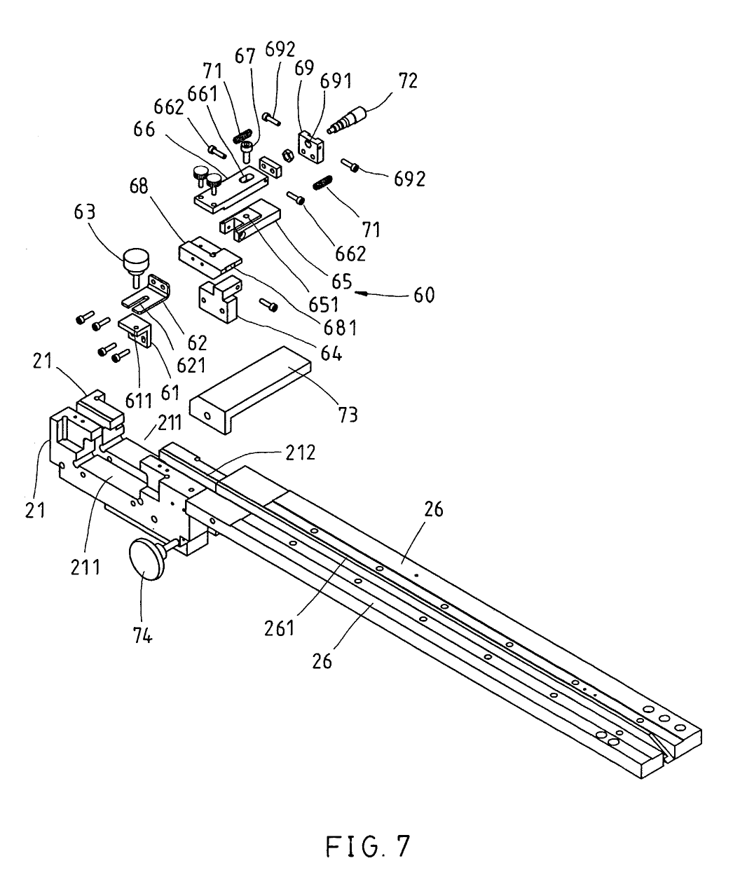

As shown in FIGS. 2-7, the film-sealing device provided by a preferred embodiment of the present invention comprises a main base 10, two side bases 20A, 20B disposed oppositely on the main base 10, two bearing bases 30 disposed respectively on the two side bases, two press bases 40 disposed respectively on the two side bases, and a film-adjusting mechanism 60 disposed between the two side bases.

The main base 10 has two slide mounts 11 with each of which having two support abutments 12 and a cross bar 13 stridden over the abutments. The two support abutments 12 are fixed on the table of the complete set of a mechanical equipment (note: no explication will be given to the table which is not the objective of the present invention). The circumference of each cross bar 13 is provided with several ring trapped grooves 131 as shown in FIG. 3.

Each one of the two side bases 20A, 20B comprises a main block 21 and an auxiliary block 22 while the main blocks 21 on the two side bases 20A, 20B are set up with a position corresponding to each other and the inner surfaces of the two main blocks are parallel. The central portion for each main block 21 has a concavity 211 which goes indented from the top surface thereof. The rear and front ends on the bottom side of the main block 21 of the side base 20A, which is referred to the first side base hereinafter, are respectively fastened with a slide block 23 having a two-way penetrating pivot hole 231. The two slide blocks 23 are respectively sleeved on the cross bars 13 of the main base 10 by means of the pivot holes 231 thereof, consequently making a two-way slide along the bars 13. The slide block 23 is provided inside the pivot hole 231 with a wedged ball 24, as shown in FIG. 3, which is able to protrude or recoil. The wedged ball 24 can be engaged in one of the ring grooves 131 of the cross bar 13 so as to hold the slide block in a predetermined position on the cross bar 13. The rear and front ends on the top side of the main block 21 of the first side base 20A are respectively fastened with a pressing plate 25 extending toward the other side base 20B, which is referred to the second side base hereinafter, and pressing on the top surface of the main block 21. The inside top edge of the main block 21 of the second side base 20B is provided with a shoulder 212 extending along the edge thereof and being lower than the top surface of the main block 21.

The auxiliary blocks 22 of the side bases are respectively fastened to the external sides of the main blocks 21 and situated below the concavities 211. The auxiliary block 22 is provided with a piercing hole 221 at the center portion thereof, two pivot holes 222 at the lateral portions thereof, two horizontal-stretch slide grooves 223 disposed respectively between the piercing hole 221 and the pivot holes 222, two threaded holes 224 disposed respectively adjacent to said pivot holes 222, and an inserted hole 225 disposed at the center portion of the external side thereof. The second side base 20B is fixed on the table of the equipment that is unable to be moved.

The rear ends of the main blocks 21 of the two side bases 20A, 20B are respectively connected to a strip-shape side bar 26 going in front-backward direction, with the inner surfaces of the two bars displaying planes in reciprocal parallel which are flush with the respective inner surface of the main block 21. In addition, the inner top edge of the side bar 26 which is in a position corresponding to one side of the second side base 20B has a shoulder 261 which is flush with the shoulder 212 of the main block 21 of the second side base 20B.

Operators can push the first side base 20A, making it a two-way slide on the main base 10 and to be fixed on a predetermined position by way of the wedged ball 24 and the ring trapped grooves 131, thus helping adjust the spacing between the two side bases 20A, 20B.

The two bearing bases 30 are respectively mounted on the two side bases 20A, 20B, with each of which comprising two slide bars 31 movably received in the slide grooves 223 respectively, two bolts 32, a connecting block 33 having a through threaded hole 331 and connected to the external sides of the two slide bars 31 and situated at the external side of the auxiliary block 22, a twisted bolt 34, a side block 35 and bolster 36. The slide bar 31 is provided with a paddle 311 disposed on the top surface of the auxiliary block 22, and a long slot 312 on the paddle 311. The two bolts 32 pass respectively through the long slots 312 of the two slide bars 31 in a downward direction and being screwed into the threaded holes 224 of the auxiliary block 22. The twisted bolt 34 is drilled inwardly into the threaded hole 331 of the connecting block 33, with its inner end let in the inserted hole 225 of the auxiliary block 22. The side block 35 is connected to the inner end of the two slide bars 31 roughly makes up the concavity 211 of the main block 21, with its inside top edge going parallel with the inside top edge of the main block 21. The bolster 36 is connected pivotally to the inner surface of the side block 35 by a shaft 37, with its top face being lower slightly than the top face of the side block 35 such that the bolster 36 is cable of inclining forwardly and backwardly.

Consequently, the bearing base 30 can be moved leftward and rightward on the side bases 20A, 20b by turning the twisted bolt 34, i.e. to adjust the position and spacing of the two bolsters 36.

The two press bases 40 are respectively mounted on the two side bases 20A, 20B, with each of which comprising two pivot rods 41 movably passing through the two pivot holes 222 of the auxiliary block 22 of the side base, a bottom block 42 screwed at the rear and front ends thereof on the top ends of the two pivot rods 41 and situated on the top of the auxiliary block 22, a seat block 43 mounted on the top of the bottom block 42 and having a through threaded hole 431 and two longitudinal threaded holes 432, a slide block 44 mounted on the top of the seat block 43 and having two horizontal-extending long slots 441 disposed at rear and front ends thereof and a inserted hole 442 at the external center portion thereof, two bolts 45 respectively passing through the long slots 441 of the slide block 44 downwardly and screwed into the threaded holes 432 of the seat block 43, a twisted bolt 46 drilled inwardly into the threaded hole 431 of the seat block 43 with its inner end let in the inserted hole 442 of the slide block 44, a first bakelite-made packing-up block 47 mounted on the top of the slide block 44, a extension block 48 mounted at the external end thereof on the top of the first packing-up block 47, two second bakelite-made packing-up bocks 49 respectively mounted on the front and rear ends of the bottom of the extension block 48, and a heating element 51 mounted on the bottoms of the two second packing-up blocks 49 and provided at the inner end of the bottom thereof with a front-and-backwardly extended flange 511 corresponding in location above the bolster 36.

Consequently, the slide block 44 can move leftward and rightward on the seat block 43 by turning the twisted bolt 46, i.e. to adjust the position and spacing of the two flanges 511.

In addition, the two press bases 40 can produce a longitudinal moving on the two side bases 20A, 20B, with the control of its hoisting and lowering movement being subject to one driving device. In this embodiment, an oil cylinder 52 is set up on the bottom of the piercing hole 221 of the auxiliary block for each side base, with its piston rod 521 passing upwardly through the piercing hole 221 and being connected to the center of the bottom block 42 of the press base 40, thus enabling to drive the press base 40 moving up and down. The lifting and driving device, however, is not the objective of the present invention and we don't give detailed description.

The film-adjusting mechanism 60 is mounted adjacent to the rear end of the top of the main block 21 of the two side bases 20A, 20B, which comprises a first threaded member 61 mounted on the external side of the main block 21 of the first side base 20A and having a longitudinal threaded hole 611, a first slotted member 62 mounted on the top of the first threaded member 61 and having a horizontal-extending long slot 621, a bolt 63 passed through the long slot 611 of the first slotted member 61 downwardly and screwed into the threaded hole 621 of the first threaded member 62, a fixed block 64 mounted on the external side of the main block 21 of the second side base 20B, a second threaded member 65 pivoted at the inner end thereof to the fixed block 64 to make the outer end of the second threaded member 65 being able to swing up and down and having a longitudinal threaded hole 651, a second slotted member 66 mounted on the top of the second threaded member 65 and having a horizontal-extending long slot 661 and two bolts 662 respectively disposed at the front and rear sides of the external end thereof, a stopping bolt 67 passed through the long slot 661 of the second slotted member 66 and screwed into the threaded hole 651 of the second threaded member 65, a guiding element 68 interconnected between the first slotted member 62 and the second slotted member 66 and located above a gap formed between the two main blocks 21, said guiding element 68 having a rear slant disposed at the rear end of the bottom thereof and facing rearward and downwardly, and a penetrating mouth 681 extending downwardly from the rear end to the bottom thereof while its horizontal width going correspondingly to the transparent film width, an end element 69 mounted on the external of the second threaded member 65 and having a threaded hole 691 and two bolts 692 respectively disposed at the rear and front sides, two tension springs 71 respectively connected at the two ends thereof to the blots 692 of the end element 69 and the bolts 662 of the second slotted member 66, and a twisted bar 72 screwed in the threaded hole 691 of the end element 69 with its inner end stopped at the second slotted member 66.

Consequently, the guiding element 68 can be led toward the first side base 20A if turning the twisted bar 72 inwardly; conversely, the spring 71 will pull the guiding element 68 back to the second side base 20B if turning the twisted bar 72 outwardly. That is, left-and-right displacement of the guiding element 68 can be adjusted by turning the twisted bar 72.

Besides, while a replacement of the guiding element 68 is required in compliance with the width of the transparent film, take off the bolt 63 first, followed by pressing one end of the twisted bar 72 by taking the inner end of the second threaded member 65 as the pivot point to make the guiding element 68 and the first slotted member 62 a raising position. After a replacement of the guiding element 68 with a penetrating mouth 681 in a suitable width, turn the twisted bar 72 back to the horizontal degree and lock up the bolt 63.

Adjacent to the rear of the film-adjusting mechanism 60, i.e. the front end of the two side bars 26, there sets a guiding board 73 which is mounted on the front end of one of the side bars 26 by a bolt 74 with its bottom pressed on the top of the two side bars 26. The guiding board 73 has an upper-front slant facing frontward and upwardly and going compatible with the rear slant of the guiding element 68.

While employing the film-sealing device of the present invention, lay a reel packing strap which is inlaid IC packages or electronic elements in advance on the bottom of the two side bars 26 and then have the strap pulled out backwardly by passing upwardly over the rear of the roller (not shown in the drawings) in the rear end of the two side bars 26, followed by an extension to the space between the main blocks 21 of the two side bases 20A, 20B along the gap between the two side bars 26 prior to the rolling operation (note: as a conventional technology, no further description about rolling and forward moving of the packing strap will be given). In process of operation, two side edges of the packing strap are squeezed and guided by the inner edges of the two side bars 26 and two main blocks 21, and the side part of the packing strap that is set up with circular holes is pressed on the shoulder 261 of the side bar 26 in a corresponding position and the shoulder 212 of the main block 21 of the second side base 20B; besides, in the central section between the two side bases 20A, 20B, the two sides of the packing strap are pressed respectively on the top face of the bolster 36 of the two bearing bases 30, and furthermore, the packing strap passes through the guiding board 37 and bottom of the two pressing plates 25, making the packing strap a stable and smooth moving.

On the other hand, there exists a roll of transparent film above the top of the two side bars 26 to be directly pulled down forwardly by reaching the bottom side of the guiding element 68 through the penetrating mouth 681 of the film-adjusting mechanism 60 and passing through the lower part of the two pressing plates 25 such that the transparent film is able to be adherent to the top face of the packing strap.

While exerting the force as a result of a driving, the two press bases 40 are able to press both sides of the transparent film to be adherent to both sides of the top face of the packing strap by way of the flange 511 on the bottom side of the two heating elements 51. In the process of operation, the two bolsters 36 pressed on both sides of the packing strap can produce a corresponding slant according to the levelness, making the flanges 511 to press the film flatly on the packing strap.

As mentioned above, the spacing space between the two side bars 26 (between the two side bases 20A, 20B), the positions and spacing of the two bolsters 36, the flange 511 position and spacing of the two heating elements 51 and the position and width of the penetrating mouth 681 of the guide element 68 are available to operators for simple and swift adjustment or replacement. Therefore, the film-sealing device of the present invention can be applied to packing straps in different breadth, and, furthermore, flexible adjustment can be conducted according to the recessed chamber width and the position of the packing strap or the width of the transparent film and the adherent position anticipated. Consequently, the present invention is able to help producers to lower the equipment cost and reduce room taken up by the equipment.

What is claimed is:

1. A film-sealing device comprising:
a main base;
two side bases mounted oppositely on the main base with at least one of which being able to move leftward and rightward on the main base, each said side base having a concavity indented from the top surface thereof, one of said side bases having a shoulder located at the inner top edge thereof;
two bearing bases respectively mounted on the two side bases and being able to adjust leftward and rightward their positions on the side bases, each bearing base provided at the inner side thereof with a bolster corresponding in location to the concavity of said side base substantially, the top surface of one of the bolsters being substantially flush with the shoulder of said side base; and
two press bases respectively mounted on the two side bases and being able to adjust leftward and rightward their positions on the side bases, each press base provided at the inner side thereof with a heating element which is provided at the bottom thereof with a front-and-backwardly extended flange corresponding in location above the bolster, the two press bases being able to move up and down on the side bases.

2. The film-sealing device as defined in claim 1, wherein the main base has two slide mounts with each of which having two support abutments and a cross bar stridden over the abutments and having a plurality of grooves at the circumference thereof; the film-sealing device further comprising two slide blocks fastened at the rear and front ends on the bottom of one of the side bases with each of which having a pivot hole provided with a wedged ball which is able to protrude or recoil, said two slide blocks being respectively movably sleeved on the cross bars of the main base by means of the pivot holes thereof such that the wedged balls are able to be respectively engaged in one of the grooves of the cross bars so as to hold the slide blocks in a predetermined position on the cross bars; the other side base being kept in a fixed position corresponding to said main base.

3. The film-sealing device as defined in claim 1, wherein each said side base comprises a main block and an auxiliary block mounted on the main block and having an inserted hole, two slide grooves and two threaded holes, the main blocks of the two side bases are arranged in parallel;
wherein each said bearing base comprises two slide bars movably received in the slide grooves of the respectively with each of which having a paddle disposed on the top surface of the auxiliary block and a long slot on the paddle, two bolts passing respectively through the long slots of the two slide bars and being screwed into the threaded holes of the auxiliary block, a connecting block having a through threaded hole and connected to the external sides of the two slide bars, a twisted bolt screwed into the threaded hole of the connecting block with its inner end let in the inserted hole of the auxiliary block, a side block connected to the inner end of the two slide bars and roughly made up the concavity of the main block with its inside top edge going parallel with the inside top edge of the main block, and said bolster connected pivotally to the inner surface of the side block with its top face being lower slightly than the top face of the side block such that the bolster is cable of inclining forwardly and backwardly.

4. The film-sealing device as defined in claim 1, wherein each said side base comprises a main block and an auxiliary block mounted on the main block and having two pivot holes, the main blocks of the two side bases are arranged in parallel;
wherein each said press base comprises two pivot rods movably passing through the two pivot holes of the auxiliary block of the side base, a bottom block screwed at the rear and front ends thereof on the top ends of the two pivot rods and situated on the top of the auxiliary block, a seat block mounted on the top of the bottom block and having a through threaded hole and two longitudinal threaded holes, a slide block mounted on the top of the seat block and having two horizontal-extending long slots disposed at rear and front ends thereof and a inserted hole at the external center portion thereof, two bolts respectively passing through the long slots of the slide block and screwed into the longitudinal threaded holes of the seat block, a twisted bolt drilled inwardly into the through threaded hole of the seat block with its inner end let in the inserted hole of the slide block, a first bakelite-made packing-up block mounted on the top of the slide block, a extension block mounted at the external end thereof on the top of the first packing-up block, two second bakelite-made packing-up bocks respectively mounted on the front and rear ends of the bottom of the extension block, and said heating element mounted on the bottoms of the two second packing-up blocks.

5. The film-sealing device as defined in claim 1 further comprising a film-adjusting mechanism which comprises a first threaded member mounted on the external side of one of the side bases and having a longitudinal threaded hole, a first slotted member mounted on the top of the first threaded member and having a horizontal-extending long slot, a bolt passed through the long slot of the first slotted member and screwed into the threaded hole of the first threaded member, a fixed block mounted on the external side of the other side base, a second threaded member pivoted at the inner end thereof to the fixed block to make the outer end of the second threaded member being able to swing up and down and having a longitudinal threaded hole, a second slotted member mounted on the top of the second threaded member and having a horizontal-extending long slot and two bolts respectively disposed at the front and rear sides of the external end thereof, a stopping bolt passed through the long slot of the second slotted member and screwed into the threaded hole of the second threaded member, a guiding element interconnected between the first slotted member and the second slotted member and located above a gap formed between the two side bases, said guiding element having a rear slant disposed at the rear end of the bottom thereof and facing rearward and downwardly, and a penetrating mouth extending downwardly from the rear end to the bottom thereof, an end element mounted on the external of the second threaded member and having a threaded hole and two bolts respectively disposed at the rear and front sides, two tension springs respectively connected at the two ends thereof to the blots of the end element and the bolts of the second slotted member, and a twisted bar screwed in the threaded hole of the end element with its inner end stopped at the second slotted member, and a guiding board mounted adjacent to the rear of the film-adjusting mechanism and having an upper-front slant facing frontward and upwardly and going compatible with the rear slant of the guiding element.

6. The film-sealing device as defined in claim 1, wherein the rear ends of the two side bases are respectively connected to a strip-shape side bar going in front-backward direction, with the inner surfaces of the two bars displaying planes in reciprocal parallel which are flush with the respective inner surface of the side bases, one of the side bars is provided at the inner top edge thereof with a shoulder which is flush with the shoulder of the respective side base.

7. The film-sealing device as defined in claim 1, wherein the rear and front ends on the top side of the side bases are respectively fastened with a pressing plate extending toward the other side base and pressing on the top surfaces of the side bases.
